(19) United States
(12) Patent Application Publication
(10) Pub. No.: US 2009/0133430 A1
(43) Pub. Date: May 28, 2009

(54) DISPENSING SYSTEM AND METHOD FOR DISPENSING FLUID IN AN APPLIANCE

(75) Inventors: John J. Roetker, Louisville, KY (US); Natarajan Venkatakrishnan, Louisville, KY (US); Darko Ilickovic, Mount Washington, KY (US); Brian Schork, Louisville, KY (US)

Correspondence Address: Fay Sharpe LLP, 1228 Euclid Avenue, 5th Floor, The Halle Building, Cleveland, OH, 44115, US

(73) Assignee: General Electric Company, Schenectady, NY (US)

(21) Appl. No.: 11/946,693

(22) Filed: Nov. 28, 2007

(51) Int. Cl. B67D 5/62

(52) U.S. Cl. 62/393; 222/146.6; 222/52; 222/1

(57) ABSTRACT

A dispensing system and method for storing and dispensing a temperature controlled fluid from an appliance includes a tank for storing the temperature controlled fluid and a dispenser outlet for dispensing the temperature controlled fluid. A dispenser fluid line fluidly couples the tank and the dispenser outlet. A pump dispenses the temperature controlled fluid from the tank through the dispenser outlet upon receipt of a dispense signal and subsequently withdraws any residual temperature controlled fluid from the dispenser fluid line.

### BACKGROUND

The present disclosure generally relates to appliances, such as refrigerators, and more particularly relates to a dispensing system and method for dispensing fluid in an appliance. In one embodiment, a refrigerator dispensing system includes a temperature controlled water tank for holding water, a dispenser outlet fluidly connected to the tank by a dispenser fluid line, and a reversible pump that selectively moves the water held in the tank through the dispenser fluid line to the dispenser outlet and selectively removes residual water remaining in the dispenser fluid line after dispensing through the dispenser outlet back into the water tank. The dispensing system and method will be described with particular reference to this embodiment, but it is to be appreciated that it is also amenable to other like applications (e.g., using other fluids, being employed in another type of appliance, etc.).

By way of background, appliances, such as refrigerators, sometimes include a water dispensing system having a water storage tank for storing and cooling water to be dispensed. Further, some water dispensing systems include a water filter connected to the water storage tank and located in a fresh food or freezer food compartment of a refrigerator. Conventional water dispensing systems are usually concerned with the dispensing of cooled water from a refrigerator.

One problem associated with dispensing systems of prior art refrigerators is the handling of residual water remaining in a dispenser fluid line after a portion of water is dispensed through an outlet. It can be difficult to maintain a desired temperature of the residual water remaining in the dispenser fluid line. As a result, the next time water is dispensed through the outlet, the residual water is dispensed for a time before temperature controlled water is dispensed from the tank. Because the residual water is not temperature controlled, the dispensed water or at least a portion thereof may be provided at an undesirable temperature.

### SUMMARY

According to one aspect, a water dispensing system for an appliance is provided. More particularly, in accordance with this aspect, the water dispensing system includes a temperature controlled water tank for holding water and a dispenser outlet fluidly connected to the tank by a dispenser fluid line. A reversible pump selectively moves the water held in the tank through the dispenser fluid line to the dispenser outlet and selectively removes water remaining in the dispenser fluid line after dispensing through the dispenser outlet back into the water tank.

According to another aspect, a system for storing and dispensing a temperature controlled fluid from an appliance is provided. More particularly, in accordance with this aspect, the system includes a tank for storing the temperature controlled fluid and a dispenser outlet for dispensing the temperature controlled fluid. A dispenser fluid line fluidly couples the tank and the dispenser outlet to one another. A pump is provided for dispensing the temperature controlled fluid from the tank through the dispenser outlet upon receipt of a dispense signal and subsequently withdrawing any residual temperature controlled fluid from the dispenser fluid line.

According to yet another aspect, a method for dispensing temperature controlled water in an appliance is provided. More particularly, in accordance with this aspect, the temperature controlled water is dispensed through a dispenser line to a dispenser outlet upon receipt of a dispense signal triggered at the dispenser outlet. After dispensing, the temperature controlled water remaining in the dispenser line is retracted to remove the water from the dispenser line.

According to still yet another aspect, a system provides a hot or cold water dispensing system within an appliance, such as a refrigerator, which delivers instant hot or cold water. The system, after each dispense, retracts the remaining water in tubing connecting a tank to a dispenser outlet back into the tank for heating or cooling so that the initial volume dispensed is hot or cool as desired and thereby avoiding the need to purge the cold or warmed water in the tube before hot or cool water is delivered. Such retraction also prevents dribble caused by the expansion of water when heated.

According to still another aspect, a dispensing system is provided for dispensing water from an appliance independent of an inlet water supply pressure. More particularly, in accordance with this aspect, the system includes a tank for holding water and a dispenser outlet for dispensing the water. A dispenser fluid line fluidly couples the tank and the dispenser outlet. A pressure varying device dispenses the water held in the tank through the dispenser fluid line to the dispenser outlet upon receipt of a dispense signal.

Still other features and benefits of the present disclosure will become apparent to those skilled in the art upon reading and understanding the following detailed description.

### BRIEF DESCRIPTION OF THE DRAWINGS

FIG. 1 is an exploded perspective view of a refrigerator having a system for storing and dispensing a temperature controlled fluid.

FIG. 2 is a schematic view of the system of FIG. 1 showing a tank fluidly coupled to a dispenser outlet by a dispenser fluid line.

FIGS. 3 and 4 are schematic views of an expansion chamber provided along the dispenser fluid line, the expansion chamber shown prior to dispensing (FIG. 3) and during dispensing (FIG. 4).

FIG. 5 is a perspective view of an alternate refrigerator having the system for storing and dispensing a temperature controlled fluid.

### DETAILED DESCRIPTION

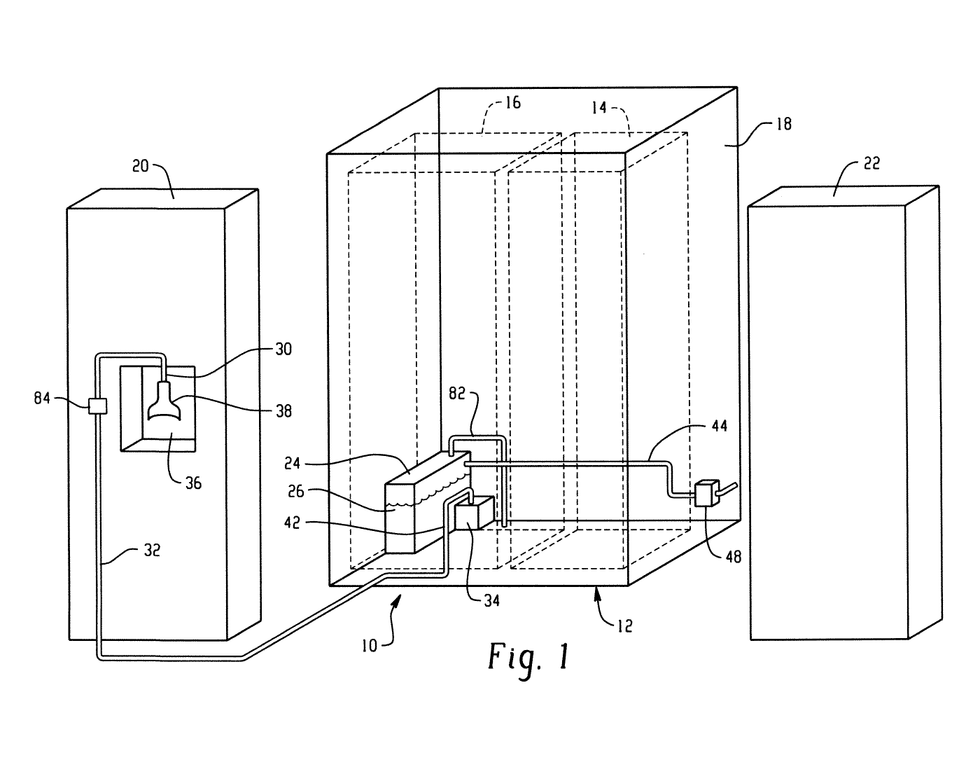

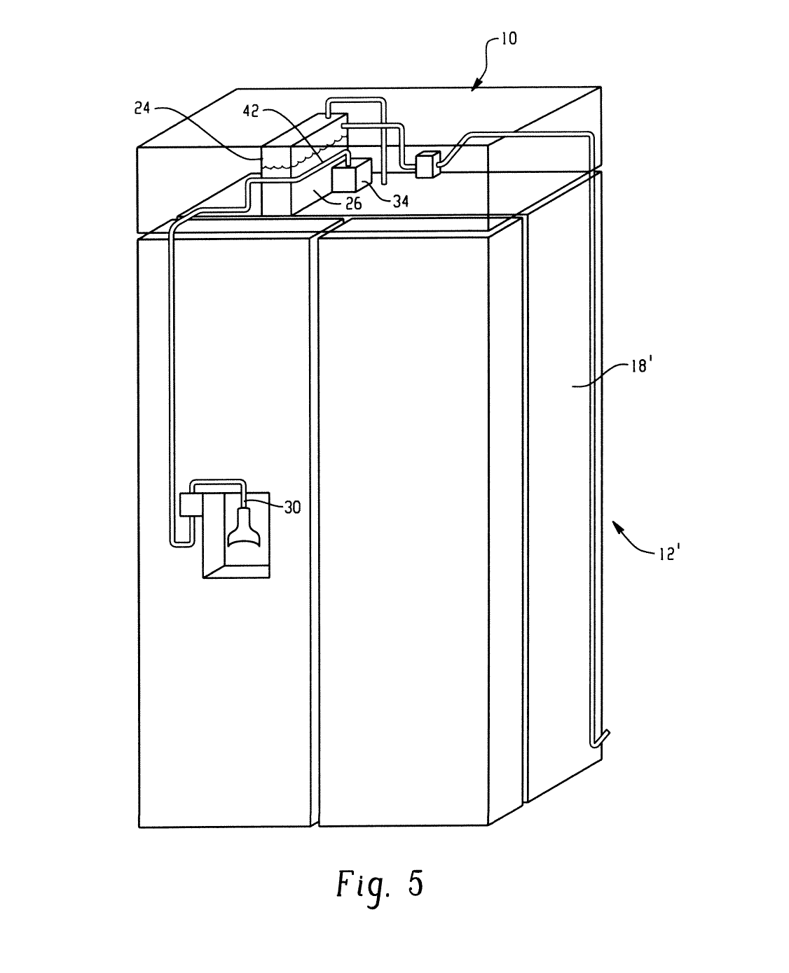

Referring now to the drawings wherein the showings are for purposes of illustrating one or more exemplary embodiments, FIG. 1 shows a system for storing and dispensing a fluid from an appliance, the system being generally designated by reference numeral 10. In the illustrated embodiment, the appliance with which the system 10 is associated is a refrigerator 12, but it is to be appreciated that the appliance could be any other type of appliance in which it is desirable to deploy the dispensing system 10. The illustrated refrigerator 12 is a side-by-side refrigerator having refrigerated and freezer compartments arranged in side-by-side relation relative to one another. It is to be appreciated that when the appliance is a refrigerator, the refrigerator need not be of the illustrated type. For example, with reference to FIG. 5, the refrigerator can be a side-by-side refrigerator 12′ like the refrigerator 12 but with the system 10 primarily disposed in a portion of a refrigerator cabinet 18′ located over side-by-side freezer and fresh food compartments and doors therefor. Alternately, the refrigerator can be a side-by-side refrigerator with a bottom freezer drawer or compartment, the refrigerator could have only a single door, or could be of some other configuration or type.

The side-by-side refrigerator 12 of the illustrated embodiment can include a fresh food storage compartment 14 and a freezer storage compartment 16, the compartments 14, 16 arranged in side-by-side relation with one another. The compartments 14, 16 can be contained within or defined by a main refrigerator portion or casing 18. Doors 20, 22 can be respectively disposed over the storage compartments 14, 16. For example, door 20 can be provided over the freezer compartment 16 for providing selective access thereto and likewise door 22 can be provided over the refrigerator compartment 14.

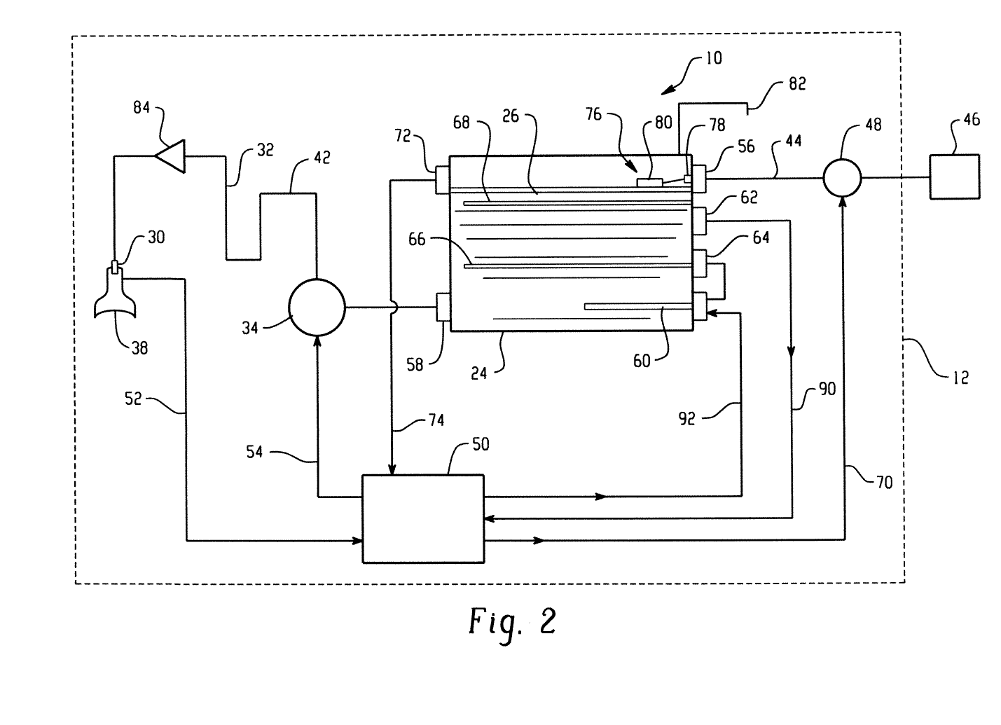

In any configuration, the system 10 can include a temperature controlled tank 24 for storing a temperature controlled fluid, such as water 26 (FIG. 2). When the temperature controlled tank 24 is employed, the system 10 is a system for storing and dispensing a temperature controlled fluid. When the temperature controlled fluid is water, the system 10 can be referred to as a water dispensing system and the tank 24 can be referred to as a temperature controlled water tank for holding water. Of course, it should be appreciated that the fluid need not be limited to water and thus could be some other fluid capable of being temperature controlled by the system 10 as will be described in more detail below. In addition, the system 10 need not include a temperature controlled tank (e.g., tank 24) and can simply be a system for dispensing a fluid or water from an appliance independent of an inlet water supply pressure.

As shown in FIG. 1, the tank 24 can be located in a lower rear portion of the main portion or casing 18, which can also be referred to as a main cabinet. In the illustrated embodiment, the tank 24 is particularly illustrated as being mounted in a rear lower portion of the main cabinet 18 behind the freezer compartment 16. As will be understood and appreciated by those skilled in the art, the mounting location of the tank 24 can vary. For example, the tank 24 can be mounted at or near a top of the main cabinet 18 or at some other convenient location.

With additional reference to FIG. 2, the system 10 further includes a dispenser outlet 30 for dispensing the temperature controlled fluid 26 from the tank 24. In particular, the dispenser outlet 30 is fluidly connected to the tank 24 by a dispenser fluid line 32. Thus, the dispenser fluid line 32 fluidly couples the tank 24 and the dispenser outlet 30. The system 10 also includes a pressure varying device 34 for dispensing the temperature controlled fluid 26 from the tank 24 through the dispenser outlet 30. As will be described in more detail below, the pressure varying device 34 can be a reversible pump that selectively pumps or moves the fluid 26 held in the tank 24 through the dispenser fluid line 32 to the dispenser outlet 30 when so commanded and selectively removes the fluid 26 remaining in the dispenser fluid line 32 after dispensing through the dispenser outlet 30 back into the tank 24. Alternatively, the pressure varying device 34 could be some other device or means for dispensing fluid through the outlet (e.g., a piston cylinder, diaphragm, etc.).

The fluid line 32 can be appropriately sized, at least adjacent the outlet 30, for minimizing dribble at the outlet 30; however, the cross sectional area of the fluid line 32 should be small enough to ensure proper suction when the pump 34 is reversed (i.e., too large a cross section might cause entrainment of air and result in dribbling at the outlet 30). The pump 34 can be integral with the tank 24 or positioned within close proximity to the tank 24. If separate from the tank 24, the pump can be a temperature controlled pump that has its temperature raised or lowered to be at or approach the temperature of the fluid 26 to be dispensed through the outlet 30. This prevents a temperature loss or gain at the pump when dispensing (i.e., if the pump were at a significantly different temperature than the fluid 26 being dispensed, the pump could undesirably absorb heat or impart heat to the fluid 26). When closely adjacent or integral with the tank 24, the pump 34 will tend to be at about the same temperature as the fluid 26 in the tank 24.

The dispenser outlet 30 can be disposed on a door of the refrigerator 12. For example, as shown in the illustrated embodiment, the dispenser outlet 30 is disposed within a dispenser recess 36 defined in the freezer door 20. Alternately, the dispenser outlet 30 can be provided in some other location of the appliance (e.g., refrigerator 12). For example, the dispenser outlet 30 can be disposed on an inside of one of the appliance doors or within the appliance itself (e.g., within one of the compartments 14, 16). The system 10 can further include a dispenser actuator 38 provided in association with the dispenser outlet 30 for generating a dispense signal upon actuation of the actuator 38 which causes the pump 34 to force the fluid 26 through the dispenser fluid line 32 and out through the dispenser outlet 30. As is known and understood by those skilled in the art, the actuator 38 can be a push button or lever disposed immediately behind the outlet 30 for actuation by positioning a glass or cup under the outlet 30 and pressing against the actuator 38.

As shown in FIG. 1 (and schematically in FIG. 2), the dispenser fluid line 32 can include at least a portion 42 of the dispenser fluid line 32 disposed at an elevation higher than a maximum fill level of the tank 24. That is, the fluid line portion 42 rises above the highest fluid level allowed in the tank 24 under normal operating conditions (or, alternatively, simply rises above the entire tank 24) to prevent draining of the tank 24 or filling of the fluid line 32 by gravity. This can be particularly advantageous when the system 10 is primarily disposed at an elevation above the dispenser outlet. For example, in the refrigerator 12′ of FIG. 5, the tank 24 and the pump 34 are located above the outlet 30. Without the line portion 42 rising above a maximum fluid level in the tank 24, fluid in the tank 24 might fill the fluid line 32 without a dispense signal and drain the tank 24. In addition, the dispenser fluid line 32, or at least a portion thereof, can be appropriately sized to avoid siphoning (i.e., capillary action). Particularly, the dispenser fluid line 32 can have a diameter sufficient to prevent undesirable siphoning of fluid therealong. When the dispenser outlet 30 is disposed in the door (e.g., door 20) of an appliance (e.g., refrigerator 12), mounting of the dispenser fluid line 32 can be through a hinge (not shown) of the door as is conventionally known.

The system 10 of the illustrated embodiment further includes an inlet fluid line 44 fluidly connecting the tank 24 to a fluid source 46 (such as a home's water supply line), which can have its own inlet water supply pressure. An inlet valve 48, which can be a solenoid actuated valve, is disposed on the inlet line 44 and serves to prevent fluid from the fluid source 46 from refilling the tank 44 when the pump 34 moves the fluid 26 held in the tank 24 through the dispenser fluid line 32 to the dispenser outlet 30, but allows fluid from the fluid source 46 to refill the tank 24 only after both fluid held in the tank 24 has been moved through the dispenser fluid line 32 to the dispenser outlet 30 and residual fluid in the dispenser fluid line 32 has been removed.

With particular reference to FIG. 2, the system 10 additionally includes a controller 50 linked to the dispenser actuator 38. As will be described in more detail below, the dispenser actuator 38 is capable of generating a dispense signal 52 upon actuation thereof. The controller 50 receives the dispense signal 52 from the dispense actuator 38 and is linked to the pump 34 and the inlet valve 48 for sending command signals (e.g., signals 54, 70) thereto. In particular, the controller 50 can send a pump control signal 54 to the pump 34 so the pump can dispense the temperature controlled fluid 26 from the tank 24 through the dispenser outlet 30 and subsequently withdraw any residual fluid 26 from the dispenser fluid line 32.

The command signal 54 for the pump can be referred to as a pump control signal 54. The pump command signal 54 can include a first pump control signal for commanding the pump 34 to operate in a first direction and a second pump control signal commanding the pump 34 to operate in a second, reverse direction. When the controller 50 sends the first pump control signal 54 to the pump 34, the pump moves the fluid 26 held in the tank 24 through the dispenser fluid line 32 to the dispenser outlet 30. Because it may take an amount of time for the fluid 26 in the tank 24 to move through the line 32 to the outlet 30 (e.g., five seconds), the system 10 has a predetermined delay period between an initial actuation of the dispenser actuator 38 and when fluid 26 exits the outlet 30. This predetermined delay period that precedes dispensing through the outlet 30 after the dispenser actuator 38 sends the dispense signal 54 to the controller 50 can be advantageous, particularly if the temperature controlled fluid 26 is at an elevated temperature, because it allows a user of the system 10 to prepare for dispensing after actuation of the actuator 38. When the controller 50 sends the second pump control signal 54 to the pump 34, the pump removes any residual fluid in the fluid line 32 and sends the same back to the tank 24.

The tank 24 includes an inlet 56 fluidly connected to the fluid source 46 for refilling the tank 24. The tank 24 additionally includes an outlet 58 fluidly connected to the dispenser fluid line 32. Still further, the tank 24 includes a temperature conditioning device 60 for adjusting a temperature of the temperature controlled fluid 26 and a thermostatic sensor 62 for sensing the temperature of the fluid 26. The thermostatic sensor 62 can be thermally connected to the fluid 26 and operatively coupled to the temperature conditioning device 60, such as through the controller 50, for cycling the temperature conditioning device 60 to adjust the temperature of the fluid 26 to a desired temperature.

In one embodiment, the temperature conditioning device 60 is a heating element for heating the fluid 26 within the tank 24 to a predetermined temperature, such as about 150° F. to 205° F. (about 65° C. to 99° C.). The thermostatic sensor 62 can be a thermistor. Alternately, the temperature conditioning device 60 could be a cooling element and could work in conjunction with the thermostatic sensor 62 to maintain the fluid 26 in the tank 24 at a desired or predetermined cooled temperature, such as about 50° F. (10° C.) for example.

The tank 24 can further include a high temperature cutout device 64 that prevents actuation or operation of the heating element 60 when a temperature in the tank 24 is above a predetermined temperature threshold, for example 210° F. (99° C.). The tank 24 can also include baffles 66, 68 for dispersing fluid delivered from the fluid source 46 through the inlet 56 of the tank 24. The first baffle 66 can be generally disposed in a plane parallel to a top level of the fluid 26 in the tank 24 and located vertically along the tank at approximately a location of the high temperature cutout device 64 to expedite heat transfer from the heating element 60 to the high temperature cutout device 64. The second baffle 68 is also generally disposed in a plane parallel to a top level of the fluid 26 in the tank 24, but is located vertically along the tank at approximately a location of the inlet 56. In one embodiment, the high temperature cutout device 64 is a bi-metal switch that disables the heating element 60 when the temperature in the tank 24 is above the predetermined temperature threshold and requires manual resetting after activation, though this is not required.

A fluid level sensing device 72 can be provided in association with the tank 24 for determining when a fluid level in the tank 24 is below a predetermined level. Through the controller 50, the level sensing device 72 can be used with the inlet valve 48 for controlling refilling of the tank 24 from the fluid source 46. In particular, the controller 50 can be linked to the level sensing device 72 and to the inlet valve 48 so that the controller 50 can command the inlet valve 48 to open to allow the fluid source 46 to refill the tank 24 when the level sensing device 72 indicates that the fluid level in the tank 24 is below the predetermined level, but only after any residual temperature controlled fluid 26 is withdrawn from the dispenser fluid line 32. Specifically, the level sensing device 72 can send a level sensing device signal 74 to the controller 50 for indicating a fluid level within the tank 24 to the controller 50 or at least indicating that the fluid level in the tank 24 is below the predetermined level. When the fluid level in the tank 24 is indicated by the signal 54 as being below the predetermined level and residual fluid in the fluid line 32 has already been removed by the pump 34, the controller 50 can send a command signal 76 to the inlet valve 48 for opening the inlet valve 48 and refilling the tank 24.

The tank 24 can additionally include a float valve device 76 including a float valve 78 disposed in the inlet 56 of the tank 24 and a float 80 connected to the float valve 78. The float valve 78 is normally in an open position allowing fluid communication through the tank inlet 56; however, the float 80 mechanically closes the float valve 78 when the fluid level in the tank is above a second predetermined level (higher than the first predetermined level). More particularly, should too much fluid be in the tank 24, the float 80 will rise and, when the fluid level reaches or exceeds the second predetermined level, the float 80 will cause the float valve 78 to close thereby preventing further fluid from the fluid source 46 from entering the tank 24 through the inlet 56. A vent line 82 can be connected to the tank, preferably at an upper end thereof, for venting air or pressure from the tank 24 when the fluid level in the tank increases and admitting air into the tank 24 as the fluid level decreases so as to prevent a vacuum effect from occurring.

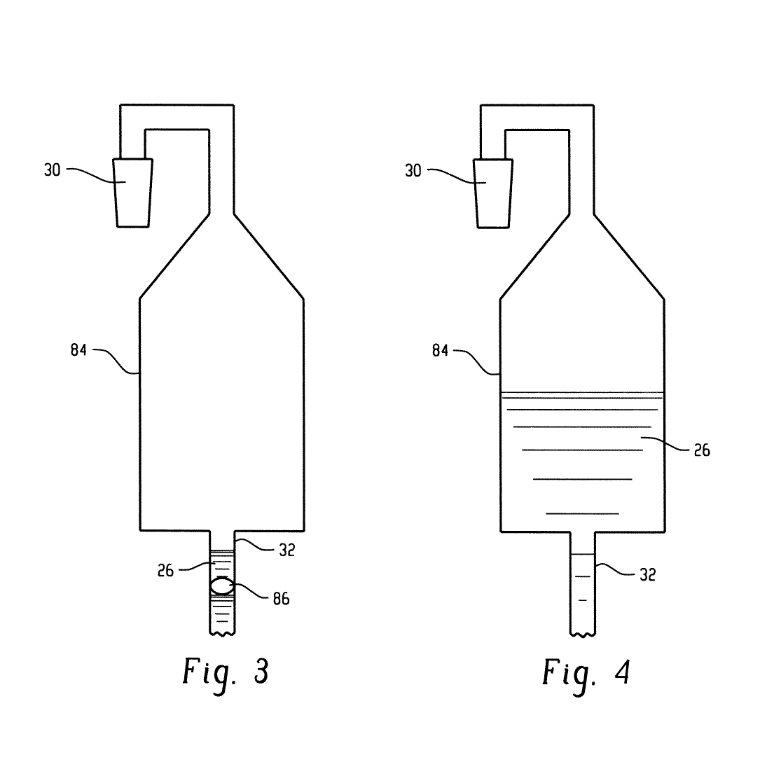

With additional reference to FIGS. 3 and 4, the fluid line 32 includes an expansion chamber 84. The expansion chamber 84 can be disposed along the fluid line 32 adjacent the dispenser outlet 30 to purge any air trapped in the fluid line 32 prior to dispensing the fluid through the dispenser outlet 30. More specifically, as shown in FIG. 3, air gaps 86 may be disposed within the fluid 26 passing through the dispense line 32. Should these air gaps pass to the outlet 30 without going through the expansion chamber 84, the resulting dispense from the outlet could fail to be constant and may cause spitting. The expansion chamber eliminates the air gaps 86, as shown in FIG. 4, and provides a continuous flow of the fluid 26 to the outlet 30.

In operation, particularly when the tank 24 is a temperature controlled tank, the system 10 allows the appliance 12 to dispense temperature controlled fluid or water without dispensing non-temperature controlled residual fluid and preventing or substantially reducing any dribble effect at the outlet 30. In particular, and with reference to the illustrated embodiment, the temperature controlled fluid 26 is dispensed through the dispenser line 32 to the dispenser outlet 30 upon receipt of the dispense signal 52 triggered at the dispenser outlet 30 by the dispenser actuator 38 (or after a predetermined delay period expires). More specifically, when the controller 50 receives the actuation signal 52, the controller 50 sends a first pump control signal 54 to the pump 34 to move the fluid 26 held in the tank 24 through the dispenser line 32 to the dispenser outlet 30. The dispensing by the pump 34 is independent and separate from the use of the inlet supply pressure from the fluid source 46 (i.e., the pump serves as an independent dispensing means that is not dependent on a pressure of the fluid 26 at the fluid source 46). More particularly, the pump 34 can be limited to dispensing water 26 held in the tank 24 through the dispenser fluid line 32 to the outlet 30 only when the inlet valve 48 is closed thereby ensuring that water 26 is dispensed through the outlet 30 independent of the inlet water supply pressure of the water source 46.

After dispensing, any fluid remaining in the dispenser line 32 (i.e., residual fluid) is retracted to remove the fluid from the dispenser line 32. More particularly, when the dispenser actuator 38, also referred herein as a dispenser trigger, is released, the signal 52 to the controller 50 ceases or indicates that no further dispensing is desired. At this time, the controller 50 sends the second command signal 54 to the pump 34 and the pump direction is reversed such that fluid within the tubing 32 is returned to the tank 24. In one embodiment, retraction of the residual fluid in the dispenser line 32 back into the tank 24 occurs only when both the dispense signal 52 indicates that dispensing has terminated (or is desired to be terminated) and a predetermined delay period expires. The predetermined delay can be seven seconds, for example, and operates to ensure that dispensing is desired to be ceased and that actuation of the dispenser trigger 38 was not stopped inadvertently.

After retraction, the tank 24 is refilled with fluid from the fluid source 46 through the tank inlet 56 after another predetermined delay (e.g., twenty seconds), though this is not required. More specifically, the controller 50 sends the inlet valve control signal 70 to the inlet valve 48 to open the inlet valve and refill the tank 24. Opening of the valve 48 by the controller 50 works in conjunction with the water level sensor 72 and its corresponding signal 74. More specifically, the water level sensor 72 indicates a water level in the tank 24 via signal 74. Using this information, the controller 50 determines how long to open the valve 48 to allow fluid from the fluid source 46 to refill the tank 24. Between dispenses and with the tank 24 filled, the controller 50 operates the temperature conditioning device 60 to maintain the fluid 26 within the tank 24 at a desired temperature. More specifically, the sensor 62 provides a temperature signal 90 to the controller 50 and, using this input, the controller 50 sends a command signal 92 to the temperature conditioning device 60 to operate the same and thereby control the temperature of the fluid 26 in the tank 24. The timed refilling of the tank 24 allows a maximum amount of the temperature controlled fluid 26 to be maintained within the tank and subsequently withdrawn from the tank prior to introducing additional fluid from the fluid source 46.

The exemplary embodiment or embodiments have been described with reference to preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

What is claimed is:

1. A water dispensing system for an appliance, comprising:
a temperature controlled water tank for holding water;
a dispenser outlet fluidly connected to the tank by a dispenser fluid line; and
a reversible pump that selectively moves the water held in the tank through the dispenser fluid line to the dispenser outlet and selectively removes water remaining in the dispenser fluid line after dispensing through the dispenser outlet back into the water tank.

2. The water dispensing system of claim 1 wherein the appliance is a refrigerator.

3. The water dispensing system of claim 2 wherein the dispenser outlet is disposed on the door of the refrigerator.

4. The water dispensing system of claim 1 wherein the dispenser fluid line includes at least a portion disposed at an elevation higher than a maximum fill level of the water tank.

5. The water dispensing system of claim 1 further including an inlet valve disposed on an inlet line fluidly connecting the tank to a water source, the inlet valve preventing water from the water source from refilling the tank while the reversible pump moves the water held in the tank through the dispenser fluid line to the dispenser outlet and allowing water from the water source to refill the tank only after water held in the tank is moved through the dispenser fluid line to the dispenser outlet and water in the dispenser fluid line is removed.

6. The water dispensing system of claim 5 further including:
a dispenser actuator for generating a dispense signal upon actuation thereof; and
a controller linked to the dispenser actuator to receive the dispense signal and linked to the reversible pump and the inlet valve for sending command signals thereto, the controller sending a first pump control signal to the reversible pump to move the water held in the tank through the dispenser fluid line to the dispenser outlet upon receipt of the dispense signal from the dispenser actuator, the controller sending a second pump control signal to the reversible pump to remove water remaining in the dispenser fluid line after dispensing through the dispenser outlet back into the water tank when both (i) the dispense signal indicates that dispensing has terminated and (ii) a predetermined delay period expires, the controller sending an inlet valve control signal to the inlet valve to open the inlet valve and refill the water tank after the reversible pump removes water remaining in the dispenser fluid line back into the tank.

7. The water dispensing system of claim 1 further including:
a dispenser actuator for generating a dispense signal upon actuation thereof; and
a controller linked to the dispenser actuator to receive the dispense signal and linked to the reversible pump to send a pump control signal, the controller sending the pump control signal to the reversible pump to move the water held in the tank through the dispenser fluid line to the dispenser outlet upon receipt of the dispense signal from the dispenser actuator.

8. The water dispensing system of claim 1 wherein the temperature controlled water tank includes a heating element for heating water within the tank to a predetermined temperature.

9. A system for storing and dispensing a temperature controlled fluid from an appliance, comprising:
a tank for storing the temperature controlled fluid;
a dispenser outlet for dispensing the temperature controlled fluid;
a dispenser fluid line fluidly coupling the tank and the dispenser outlet; and
a pressure varying device for dispensing the temperature controlled fluid from the tank through the dispenser outlet upon receipt of a dispense signal and subsequently withdrawing any residual temperature controlled fluid from the dispenser fluid line.

10. The system of claim 9 wherein the tank includes:
an inlet fluidly connected to a fluid source for refilling the tank;
an outlet fluidly connected to the dispenser fluid line;
a temperature conditioning device for adjusting a temperature of the temperature controlled fluid; and
a thermostatic sensor thermally connected to the temperature controlled fluid and operatively coupled to the temperature conditioning device for cycling of the temperature conditioning device to adjust the temperature of the temperature controlled fluid.

11. The system of claim 10 wherein the temperature conditioning device is a heating element and the thermostatic sensor is a thermistor.

12. The system of claim 11 wherein the tank further includes a high temperature cutout device that prevents operation of the heating element when a temperature in the tank is above a predetermined temperature threshold.

13. The system of claim 12 further including a tank baffle for dispersing fluid delivered from the fluid source through the inlet of the tank, the tank baffle generally disposed in a plane parallel to a top level of the fluid in the tank and located vertically at approximately a location of the high temperature cutout device to expedite heat transfer from the heating element to the high temperature cutout device.

14. The system of claim 10 further including tank baffle for dispersing fluid delivered from the fluid source through the inlet of the tank, the tank baffle generally disposed in a plane parallel to a top level of the fluid in the tank and located vertically at approximately a location of the inlet.

15. The system of claim 9 further including:
a level sensing device for determining when a fluid level in the tank is below a predetermined level;
an inlet valve disposed between the fluid source and the tank for controlling refilling of the tank from the fluid source; and
a controller linked to the level sensing device and to the inlet valve, the controller commanding the inlet valve to open to allow the fluid source to refill the tank when the level sensing device indicates controlled fluid is withdrawn from the dispenser fluid line.

16. The system of claim 12 further including a float valve device including a float valve disposed in the inlet of the tank that is normally in an open position and a float connected to the float valve to mechanically close the float valve when the fluid level in the tank is above a second predetermined level.

17. The system of claim 9 wherein the fluid line includes an expansion chamber adjacent the dispenser outlet to purge any air trapped in the fluid line prior to dispensing the fluid through the dispenser outlet.

18. A method for dispensing temperature controlled water in an appliance, comprising:
dispensing temperature controlled water through a dispenser line to a dispenser outlet upon receipt of a dispense signal triggered at the dispenser outlet; and
after dispensing, retracting the temperature controlled water remaining in the dispenser line to remove the water from the dispenser line.

19. The method of claim 18 wherein dispensing temperature controlled water includes pumping the water from a tank in a first direction to the dispenser outlet upon receipt of the dispense signal trigger at the dispenser outlet, and wherein retracting the temperature controlled water includes pumping the water in a second, reverse direction from the dispense line to the tank.

20. The method of claim 19 further including:
after retracting, refilling the tank with water through a tank inlet after a predetermined delay.

21. The water dispensing system of claim 6 wherein the inlet valve control signal is sent after another predetermined delay period expires and after the reversible pump removes water remaining in the dispenser fluid line back into the tank.

22. The water dispensing system of claim 6 wherein another predetermined delay period precedes dispensing through the dispenser outlet after the dispenser actuator sends the dispense signal to the controller.

23. The water dispensing system of claim of claim 1 wherein the reversible pump removes water remaining in the dispenser fluid line only after a dispense signal indicates that dispensing has terminated and a predetermined delay period expires.

24. A system for dispensing water from an appliance independent of an inlet water supply pressure, comprising:
a tank for holding water;
a dispenser outlet for dispensing the water;
a dispenser fluid line fluidly coupling the tank and the dispenser outlet; and
a pressure varying device that dispenses the water held in the tank through the dispenser fluid line to the dispenser outlet upon receipt of a dispense signal.

25. The system of claim 24 further including an inlet valve disposed on an inlet line fluidly connecting that tank to a water source having an inlet water supply pressure, the inlet valve movable between an open position wherein the inlet water supply pressure fills the tank with water from the water source and a closed position wherein water from the water source is prevented from filling the tank, the pressure varying device dispensing the water held in the tank through the dispenser fluid line only when the inlet valve is in the closed position thereby dispensing the water through the outlet independent of the inlet water supply pressure.
